(19) United States
(12) Patent Application Publication
(10) Pub. No.: US 2011/0161124 A1
(43) Pub. Date: Jun. 30, 2011

(54) METHOD AND SYSTEM FOR ENTERPRISE BUILDING AUTOMATION

(76) Inventors: Duane Lappinga, Palos Verdes Estates, CA (US); James Bryan, Highlands Ranch, CO (US); Brian K. Ivey, Saugus, CA (US)

(21) Appl. No.: 12/650,700

(22) Filed: Dec. 31, 2009

(51) Int. Cl. G06Q 10/00; G06Q 50/00

(52) U.S. Cl. 705/7.11; 705/314

(57) ABSTRACT

A method and system for an enterprise-level building automation system, the method includes providing building level building data to a building level building automation system (BAS) associated with a property, the building level building data including a status of building equipment; communicating building level building data provided to a plurality of different building level building automation systems (BASs), each of the plurality of different building level BASs being associated with a distinct property to an enterprise level BAS; providing energy utility data to the enterprise level BAS; monitoring the building level data associated with each distinct property in real time by the enterprise level BAS; and generating, based on the building level data and the energy utility data, a report including a graphical visualization of the building level data and the energy utility data associated with each distinct property by the enterprise level BAS.

### BACKGROUND

In some instances, an entity, such as a real estate landlord, trust, or managing company, may be interested in one or more of improving the energy efficiency, reducing operational and maintenance costs, and reducing the environmental impact associated with a property such as a building. For example, significant cost savings may be realized by effectively and efficiently controlling the cooling, heating, lighting, and other systems of a building. A building automation system (BAS) may be deployed at a building to monitor and control one or more of the systems of that particular building. However, a BAS for a building is typically associated with a particular property or building.

The amount of information monitored and gathered by a BAS associated with a particular building may be vast. Additionally, a real estate landlord, trust, managing company, or other entity interested in monitoring multiple properties they own and/or manage would further have to handle diverse information from the multiple BASs associated with the multiple different properties. The outputs of the various BASs may present a confusing amount and array of information that can be difficult to comprehend, analyze, evaluate, and/or efficiently act upon. For example, the various BASs may use different communication protocols. Also, it may be desired to use additional data sources other than the information provided by a BAS in order to achieve enhanced analysis, reporting, and control functionality in the entity's effort to, for example, improve the energy efficiency, achieve cost savings, and reduce the environmental impact associated with the multiple properties associated with the various multiple BASs.

### SUMMARY

According to some embodiments, building level data may be provided to a building level BAS associated with a property where the building level data includes a status of the building equipment associated with the particular property. Further, building data provided to a plurality of different building level BASs and energy utility data may be provided to an enterprise level BAS for monitoring and control of the building level building data associated with each distinct property by the enterprise level BAS. In some embodiments, reports may be generated based on the building level building data and the energy utility data. The reports may be processed and presented to include a graphical visualization of the building level data and the energy utility data associated with each distinct property by the enterprise level BAS.

Other embodiments may include analyzing the building level building data and the energy utility data associated with each distinct property by the enterprise level BAS. In some embodiments, the enterprise level BAS may remotely access the building level BASs and automatically perform the analysis in a building and/or portfolio benchmarking, performance evaluation, commissioning, and retro-commissioning effort. Some embodiments herein provide a web-based enterprise level BAS for accessing, programming, and controlling building level BASs.

A technical effect of some embodiments of the present disclosure is an efficient ability to collect property level data from a diverse set of BASs and to further perform portfolio wide monitoring, analysis, reporting, and control. With this and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 illustrates a system architecture for an enterprise level building automation system according to some embodiments;

FIG. 2 is a block diagram illustrating an integration of systems, in accordance with some embodiments herein;

FIG. 3 is a block diagram illustrating a system according to some embodiments;

FIG. 4 is a flow diagram of a method, according to some embodiments;

FIG. 5 is an illustrative depiction of a graphical visualization according to some embodiments;

FIG. 6 is an illustrative depiction of a graphical visualization according to some embodiments; and

FIG. 7 is an illustrative depiction of a graphical visualization according to some embodiments.

### DETAILED DESCRIPTION

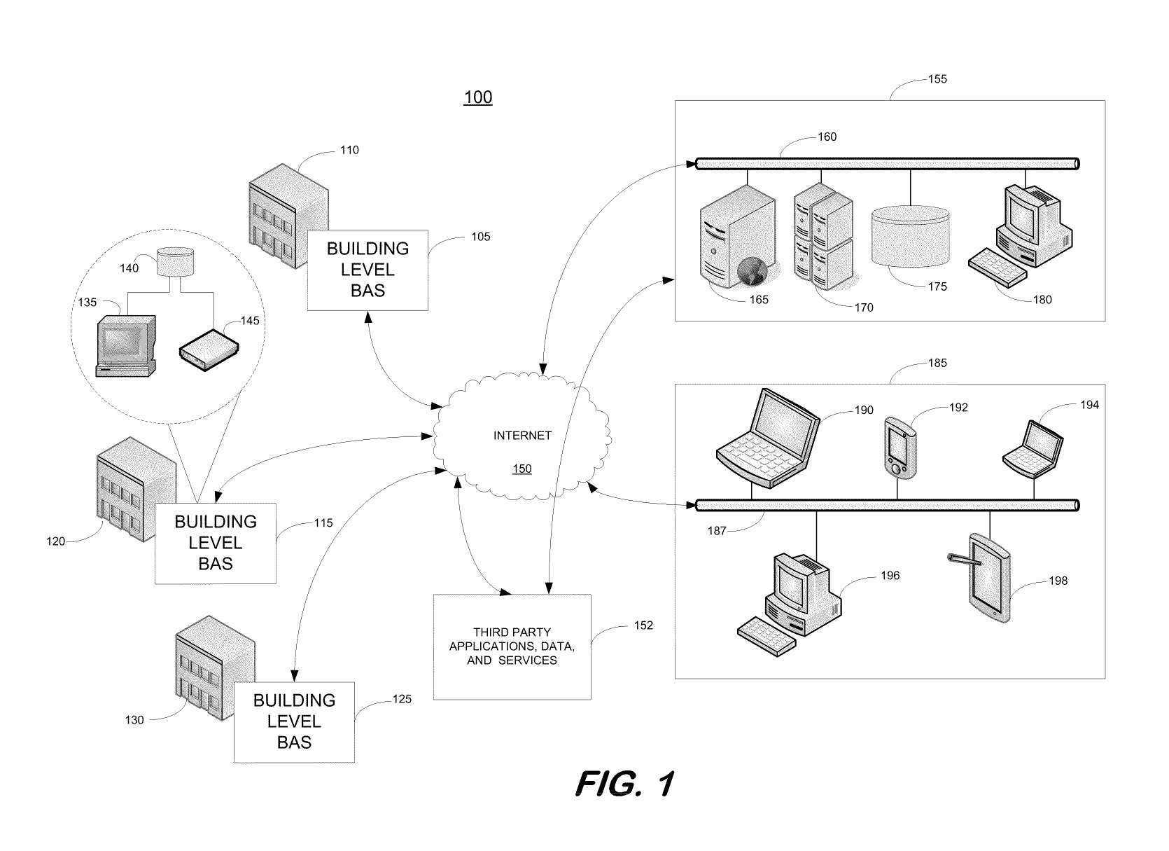

To address some of the problems introduced in the background section of this application, an enterprise level building automation system (BAS) system, apparatus and method for providing same is provided. For example, FIG. 1 is an example of a system architecture for an enterprise level BAS 100 according to some embodiments herein. In particular, an enterprise level BAS service, tool, or platform 100 may include one or more building level BASs such as BAS 105, building level BAS 115, and building level BAS 125. Each building level BAS 105, 115, and 125 is associated with a particular property. In the example of FIG. 1, building level BAS 105 is associated with building 110, building level BAS 115 is associated with building 120, and building level BAS 125 is associated with building 130. While three building level BASs are depicted in FIG. 1, enterprise level BAS 100 is not constrained to including three or any other specific number of building level BASs. For example, enterprise level BAS 100 may include fewer or more than the three BASs shown in FIG. 1. As will be better understood based on the description below, system 100 may be expanded and scaled to accommodate additional BASs as, for example, additional properties are acquired by an entity or as any other need or desire to include additional properties in system 100 develops.

The particular systems, devices, and points of interest monitored by the building level BASs 105, 115, 125 may include one or more of the various parameters capable of being monitored and controlled by a building level BAS, including those now known and those that become known in the future. While typical parameters monitored by the building level BASs may relate to the system(s) responsible for heating, cooling, lighting, and securing the buildings 110, 120, and 130, other points of interest may also be monitored by the building level BASs. In some embodiments, a monitored point of interest or parameter may relate to a form of energy consumption and/or generation.

An exemplary depiction of BAS 115 may include a user interface 135, a storage device 140, and an equipment interface or gateway 145. A building level BAS may be implemented in many varieties of configuration. A common, traditional configuration may utilize a desktop computer for the user interface and data storage, with one or more master controllers executing operations and communicating to the desktop computer. Data may be stored temporarily on the master controllers, with this data periodically being uploaded to the desktop computer for more permanent storage. In some instances, a building level BAS may not include a desktop personal computer. In such configurations, a master building controller(s) may also act as a web server and store data. The user interface may be implemented by any computer (e.g., a desktop computer, laptop computer, or even a handheld device) connected to the system via an internet connection.

Returning to FIG. 1, user interface 135 may provide a mechanism for a human user (e.g., landlord, operations manager, etc.) to access the building level BAS. In some embodiments, user interface 135 may include a personal computer, a workstation, and a laptop locally connected to building level BAS 115. In some embodiments, user interface may be located at building 120 or at least require a communication connection to BAS 115. In some embodiments, a security function may be included or otherwise associated with the building level BAS as a means of restricting access to and control of the building level BAS only to authorized personnel. The security mechanism may include one or more security features, including passwords, pass codes, encryption keys, biometrics, etc. Storage device 140 may be provided for storing building data (e.g., parameter-value pairs) monitored and gathered by the building level BAS 115. Such data may be collected and stored in a variety of formats, including for example analog values, digital values, raw values, and scaled values. Furthermore, the collected data may be formatted or unformatted according to a data management storage standard or requirement depending, for example, on a database management scheme used by data storage device 140.

In accordance with some embodiments, the data storage scheme and/or structures utilized to store the building level BAS data may differ among the BASs 105, 115, and 125. That is, BAS 105 may use a first data storage scheme, BAS 115 may store its data using a second data storage scheme, and BAS 125 may use yet another data storage scheme or system. Thus, it is seen that the building level BASs may be diverse, as each building level BAS may be distinct from the other building level BASs of system 100.

Equipment interface 145, also referred to a gateway herein, may facilitate communication between the monitored equipment of building 120 associated with building level BAS 115 and storage device 140. Equipment interface 145 may also facilitate communication between building level BAS 115 and devices, networks, and systems outside of building 120. For example, equipment interface 145 may provide a communication channel between building level BAS 115 and the other components of system 100, including network 150. In accordance with some embodiments, the communication protocol utilized to communicate building level BAS data may differ among the BASs 105, 115, and 125.

Building level BAS 115 may include components not specifically shown in FIG. 1. Such additional components, such as network components and/or controls to building systems, are understood to be included in some embodiments herein.

In some embodiments, interface equipment 145 includes functionality for communicating building level data collected from its associated building to other components and devices of the system according to a particular, determined protocol. The protocol may consider and include security aspects (e.g., encryption) and may conform to a standardized communication protocol. In some embodiments, equipment interface 145 may provide connectivity to network 150 using the network protocol of network 150 (e.g., the Internet). In some embodiments, equipment interface 145 may provide connectivity to devices and networks within the particular building with which it is associated by connecting to varying network protocols of those devices and networks. In some embodiments, the functionality of equipment interface 145 may be implemented in a number of different devices, systems, applications, and services.

Enterprise level system 100 also includes an enterprise level BAS apparatus or device 155. In some embodiments, enterprise level BAS apparatus 155 may include a server. As illustrated, enterprise level BAS apparatus 155 includes a web server 165, an application server 170, a data storage device 175, and a user interface 180 connected to each other by network 160. Network 160 may comprise a secure network, including, for example, a firewall or other security means. Web server 165 may facilitate communication over network 150 by serving web pages accessible by a web browser. In some embodiments, data and information monitored and gathered by the multiple building level BASs 105, 115, and 125 may be communication over the network 150 using a web based protocol to enterprise level BAS network 160.

Application server 170 may serve applications, services, and programs that control the monitoring, controlling, and the programming of the building level BASs from an enterprise level. Additionally, application server 170 may further include an application, program, service or module that includes rules for managing the various functions to be performed by the application server 170. In some embodiments, the functionality of application server 170 may be logically organized in modules to maintain some separation of functions and/or facilitate upgrades, maintenance, and scalability of application server 170.

Data storage device 175 provides a storage mechanism for the enterprise level BAS data. The enterprise level BAS data stored on or at data storage device 175 may include data received from the building level BASs, versions, pointers, or references to the building level building data, transformations of the building level building data, reports and other data generated by the enterprise level BAS application server 170, and data (e.g., web page components) for use by web server 165.

User interface 180 may provide means for authorized users (e.g., enterprise level BAS administrative personnel, real estate managers, and other designated users) to initiate, modify, upgrade, and otherwise gain control of or access to enterprise level BAS apparatus or device 155. Such access and control may be used to upgrade or otherwise modify the functionality of enterprise level BAS apparatus or device 155. In some embodiments, access and control may be used to determine or specify the particular aspects of the building level BASs that are to be monitored, controlled, and programmed. In some aspects, access and control may be used to determine or specify the types of analysis, report generation, and other functions (e.g., commissioning and retro-commissioning of one or more buildings in the set or portfolio of buildings associated with building level BASs 105, 115, and 125) that are to be performed by application server 170.

In some embodiments, data other than the building level building data monitored, collected, and otherwise provided by building level BASs 105, 115, and 125 may be requested, desired or used by enterprise level BAS apparatus or device 155 in performing the functions thereof. In some embodiments, data related to but not necessarily stored, accessible to, or provided by the building level BASs may be obtained, provided by, or received from a third party application, data store, or service 152. In some instances, data obtained from the third party 152 may have, at some point, been provided by a building level BASs 105, 115, and 125. In some instances, the data provided by third party 152 may be (pre)processed before it is provided to enterprise level BAS apparatus 155.

In some embodiments, some data provided by third party 152 relates to energy utility data. Such data may include utility bills, utility rates, energy compliance statements, and even weather conditions (past, present, and forecasted) that may impact energy utility consumption. The energy utility data may be actual data relating to the buildings associated with the building level BASs 105, 115, and 125. Such data may be collected by, for example, energy meters and flow sensors. The energy utility data may come from bills provided by the utility company, in which case the data originate from the utility company's meter readings. Energy data may or may not be also read by the BAS directly. In other embodiments, the energy utility data may not be directly derived from the buildings associated with the building level BASs 105, 115, and 125 but relate to other building(s) having at least one same or similar characteristic with the buildings associated with the building level BASs. Analysis of such data may reveal a correlation between the buildings associated with the building level BASs and the building(s) sharing the same or similar characteristic. The characteristic may include, for example, a property type, value, condition, location, function, design, and other aspects.

In some embodiments, third party 152 may provide data or information related to historical asset data of the properties associated with the building level BASs 105, 115, and 125. In some instances, such information may be the result of, at least in part, past building/asset monitoring and performance tracking. In some other embodiments, third party 152 may provide data related to preventive maintenance (e.g., schedules, open and closed tasks, etc.). Further information from third party 152 may relate to work orders to be completed or otherwise executed at a building in the set of buildings within the control of enterprise level BAS 100 (e.g., buildings 110, 120, and 130). The frequency, type, extent, cost of completing the work orders associated with a building and/or the portfolio of buildings may be analyzed in an effort to set benchmark, recognize problem areas, predict and/or avoid future failures, and other aspects of improving operations. In some other embodiments still, third party 152 may provide information related to tenant requests. The tenant requests for a building or set of buildings may also provide, upon examination and analysis herein, insight into the frequency, type, range, and other aspects of requests from the tenants of the corresponding buildings. Analysis of such data may used to more efficiently serve the tenants by enabling a user of system 100 to better manage tenant expectations. In some instances, effective management of tenant expectations may translate in to more satisfied tenants and thus happier and/or longer tenant-landlord relationships.

In some embodiments, third party 152 may provide data related to after hours consumption of energy. Such information may be used, in some aspects, to analyze after hours energy consumption in an effort to, for example, respond proactively to after hour requests, anticipate after hour requests, establish performance goals, and determine projects or areas of improvement that will reduce energy consumption. Requests by tenants for after hours services such as, for example air conditioning, may be handled at each building level BAS system 105, 115 and 125 and reported to the enterprise BAS 155 via the internet, system 150.

Still referring to FIG. 1, there is shown a set of users 185 connected to each other by network 187 that is in further communication with the network 150. In some embodiments, connection of the users 185 to the network 150 facilitates a web based communication of enterprise level BAS reports to the users using a common and/or standardized communication protocol that is accessible and viewable using a web browser. The use of a common and/or standardized web based communication protocol may further allow users 185 to access enterprise level BAS device 155 (if authorized) and applicable enterprise level BAS reports (also with proper authorization in some instances) using a number of devices from a variety of locations over a number of different communication channels. Such devices may include any device that includes a web browser such as, for example, a laptop 190, a smartphone 192, a netbook 194, and PC 196, and other devices such as device 198 that may include a tablet computer and an e-book reader. In some aspects herein, network 185 may incorporate one or more security features such as the examples of encryption and a firewall.

In some embodiments, users 185 may be asked or required to submit to an authentication process before or during their effort to gain access to enterprise level BAS 100, including communication with enterprise level device 155. In some aspects, users 185 may include one or more users, each located in a location dispersed from the other users. In accordance with other aspects herein, users 185 may access enterprise level BAS 100 using a device having a web browser in communicative contact with enterprise level BAS device 155.

In some aspects, third party 152 may be hosted, at least in part, by an entity that also hosts other components of enterprise level BAS 100. By way of example, a realty management group implementing enterprise level BAS 100 may, in some instances, also host or provide some of the data discussed herein as being provided by third party 152. In other embodiments, entities other than the entity that also hosts other components of enterprise level BAS 100 may provide all of the data discussed herein as being provided by third party 152. Such data may be gathered from a number of public, private, proprietary, and collaborative sources. In some embodiments, third party 152 may include a call center that gathers or otherwise collects at least some of the data discussed herein as being provided by third party 152. Facility benchmarking data, weather data and building occupancy data may be provided to system 100 via their party systems and services 152.

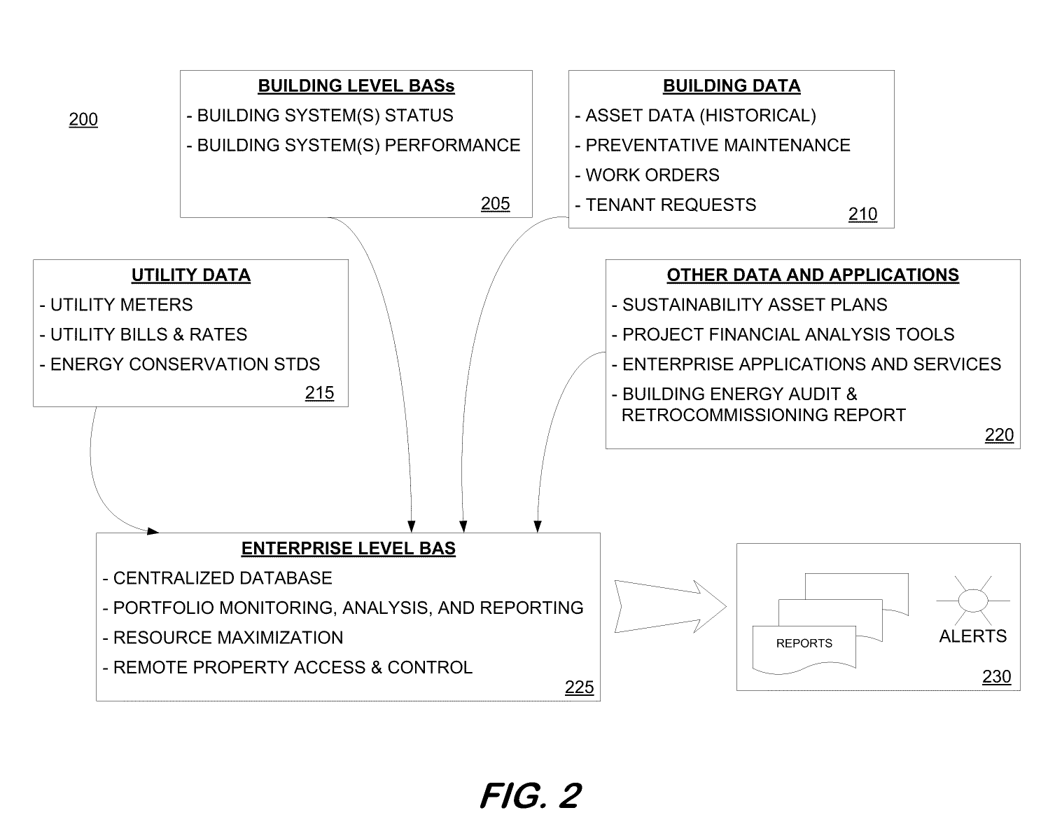

FIG. 2 is a block diagram illustrating an integration of systems, in accordance with some embodiments herein, generally referred to by reference numeral 200. The various systems include, in general, building level BASs 205, building data system 210, utility data system 215, other data and application system 220, and enterprise level BAS 225. Enterprise level BAS may generate and output reports and alerts via a presentation system 230. It is noted that one or more of the systems of illustrated in FIG. 2 may comprise a number and variety of components, devices, systems, and subsystems. In some embodiments, at least some of the exemplary characteristics or functions associated with the various systems 205-230 of FIG. 2 may be embodied in one or more components, devices, systems, and subsystems.

As illustrated, building level BASs 205 may operate to provide a status for one or more aspects, points of interest, keys, or parameters of building level data. In further aspects, building system performance information may be provided by and/or extracted from the building level BASs 205. The building level BASs 205 may comprise the building level BASs 105, 115, and 125 discussed in FIG. 1.

Building data system 210 may operate to provide information related to building asset data, including historical data; preventative maintenance information; work orders; and tenant requests. As such, building data system 210 may be implemented by aspects of third party applications, data, and services 152 introduced with regard to FIG. 1. It is noted that the information provided by building data system 210 may however be provided, collected, or determined by an entity owning, operating, and/or hosting the enterprise level BAS 100.

In some aspects herein, utility data system 215 in system 200 may function to provide information related to utility meters, rates, and bills; and information related to energy conservation goals and standards (e.g., Energy Star). The energy conservation standards or directives may be provided to facilitate an effort to achieve and/or maintain compliance with the energy conservation standard or directive.

In some embodiments, other data and application system 220 may include data and resources such that enterprise level BAS 100 may achieve its desired functionality and outcomes. For example, system 220 may provide or include systems that provide sustainability asset plans relating to a schedule of events that will promote the sustainability of a property under the monitoring and management control of an enterprise level BAS herein. In some other embodiments, system 220 may include tools, applications and (enterprise) services that are used by the enterprise level BAS.

In some embodiments, system 220 may provide building energy audit and retrocommissioning reports. Traditionally, such reports are generated by means of a site visit, a compilation of data and then analysis and reporting done manually for each building. In some aspects, a report or set of reports that allow for efficient retrocommissioning may be provided for each property monitored by the building level BASs 205, provide a mechanism for identifying and controlling drift properties, and provide a baseline report9s) to benchmark other, including similar, properties on a consumption basis.

Some embodiments herein provide or facilitate an enterprise level BAS that may collect equipment data via a third party work order/call center system (such as, for example third party 152 shown in FIG. 1), and may further collect energy and water consumption data, other sustainability metrics, building occupant data and equipment run time data, the enterprise level BAS 225 may generate a complete report with recommendations and projected financial results as a completely automated process. In this manner, a number of the recommendations contained in the energy audit and retrocommissioning report may be implemented by the enterprise level BAS as an automated process. Furthermore, the building performance data and the energy audit and retrocommissioning report recommendations may be summarized in an additional report such as, for example a sustainability plan per asset.

As illustrated in FIG. 2, the systems 205, 210, 215, and 220 may cooperate to provide a variety and range of information to enterprise level BAS 225. Enterprise level BAS 225 may correspond, in some embodiments to a server system such as enterprise level BAS device 155 introduced in FIG. 1. Using information provided or otherwise derived from systems 205, 210, 215, and 220, enterprise level BAS 225 may function to provide, in some aspects, a centralized database; portfolio (i.e., the collection of property assets subject to monitoring, control, and programming of an enterprise level BAS) monitoring, analysis, and reporting; resource maximization efforts to “fully” utilize aspects of a property, including a determination of what tasks should be accomplished in order to fully utilize the resources; and remote property access and control. The enterprise level BAS 225 may be capable of issuing commands to any one or a combination of the several building level BASs 205. Such commands may be generated by a user or may be automatically triggered based upon algorithms, rules, programs, services, applications, etc. residing in or otherwise invoked by enterprise level BAS 225. The algorithms, rules, programs, services, applications, etc. may consider data from systems 205, 210, 215 and 220.

It is further disclosed in FIG. 2 that enterprise level BAS 225 may operate to provide reports and alerts related to one or more of the building level BASs subject to management and control by the enterprise level BAS 225. In some aspects, the reports generated by enterprise level BAS 225 may include graphical visualizations such as dashboards and other graphical representations of information.

In some embodiments, monitoring, diagnostics, and alerting/notifying functions of enterprise level BAS 225 may operate to monitor one or more of the building level building data for the purpose of determining if the operating conditions of the one of more buildings are, based on current accurate building system measurements, within determined acceptable operating limits. It is noted that the determined acceptable operating limits may not necessarily correspond to the operating limits associated with the various systems of a building. In some embodiments, the determined acceptable limits may be established and/or maintained to enable the one or more buildings to operate in a highly efficient manner.

Thus, some embodiments herein integrate at least one or more of systems 205-220 with enterprise level BAS 225 to provide the functionality of enterprise level BAS 225.

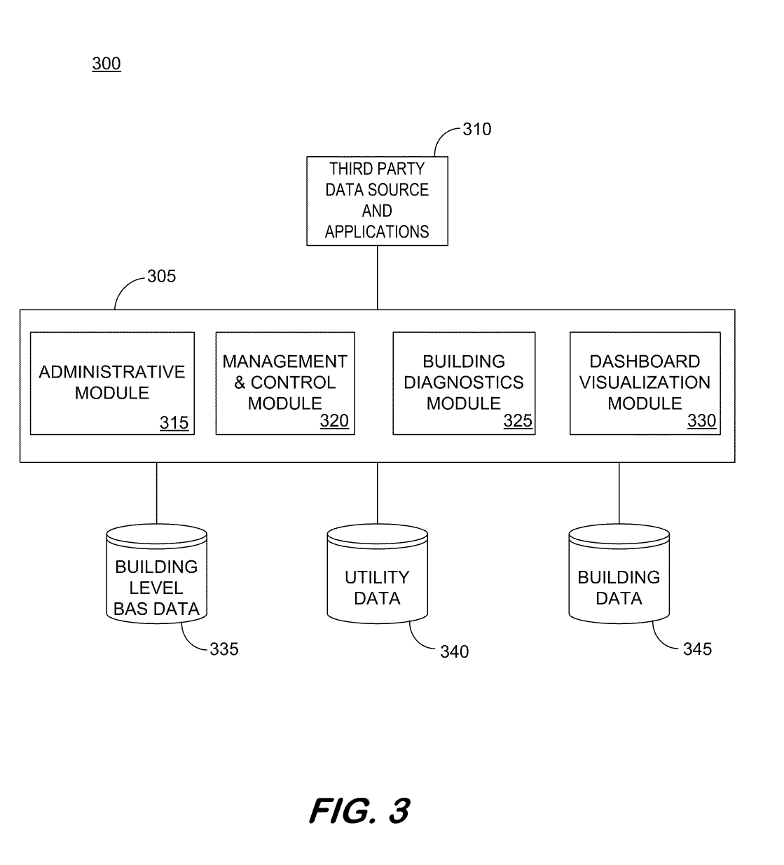

FIG. 3 relates to an enterprise level BAS device, system, and apparatus 300 that may include some aspects of some embodiments of an enterprise level BAS in accordance herewith. In some embodiments, system or device 300 may include an application server including a processor for invoking and executing a number of applications, programs, instructions, and services (e.g., application server 170 of FIG. 1). The device 300 may include a processor, microchip, central processing unit, or computer that is in communication with or otherwise uses or includes one or more communication ports (not shown) for communicating with user devices and/or other devices.

In addition to the above, the device 300 may include a memory or data storage device to store information, software, databases, messages or other communications, device drivers, etc. For example, application server 170 includes both a memory storing control program instructions for operating the server, databases, etc. The control program may control the processor associated with the processor for executing the program instructions.

The data storage devices 335, 340, and 345 may each be, for example: (i) located entirely within a single computer or other computing device; or (ii) connected to each other by a remote communication medium, such as a serial port cable, telephone line or radio frequency transceiver.

Software may be resident and operating or operational on the device 300. The software may be stored on the data storage devices and may include, in some embodiments, the software that is at least logically organized as modules wherein each module may be particularly configured to perform a specific function or utility. Enterprise level BAS 300 includes a server including a processing engine 305 that executes a number of program modules 315-330 using, for example a processor (not shown). The program modules depicted in FIG. 3 are examples of some exemplary programming modules and is not intended to be an exhaustive listing of all possible programming modules.

Administrative module 315 may relate to rules and procedures for handling administrative duties associated with an enterprise level BAS. The rules and procedures may relate to technical administrative level aspects of the enterprise level BAS, determinations of authorization rights for (potential) users, and the scheduling and coordination of communication and calls/responses between the different modules 320-330.

Management and control module 320 may relate to one or more aspects of managing and controlling properties associated with an enterprise level BAS. For example, management and control module 320 may relate to one or more aspects of managing and controlling properties associated with an enterprise level BAS. For example, the enterprise level BAS may have an ability to modify point settings to control major building equipment including changing set points, resetting equipment, adjusting equipment speed, adjusting run hours, adjusting zones, turning equipment on/off, etc. In some embodiments, module 320 may include an ability to program the building level BAS including implementing resets and schedules. Another aspect of module 320 may include an ability of enterprise level BAS 300 to view all of the building level data of the buildings associated with the building level BASs that are managed and controlled by the subject enterprise level BAS.

Regarding the building diagnostics module 325, this module may be responsible for and/or include programming to provide an ability to monitor BAS activity and diagnose issues outside of predefined property settings and define financial impacts of the issues. In some other embodiments, module 325 operates to automatically identify energy inefficiencies and their financial impacts. In some aspects, knowing the financial impacts of issues may help prioritize corrective actions. Module 325 may also include an ability to set default conditions at each property and have alerts sent when properties are outside default conditions.

Dashboard visualization module 330 may provide an ability for the enterprise level BAS to provide a graphical user interface (GUI) with a dashboard acting as a homepage. Additionally, module 330 may also provide means for the enterprise level BAS to graphically display, for example, statistics and warnings, related to building level data. In some embodiments, the graphical visualizations facilitated by module 330 may be presented on a video display device, printed, or transmitted to a person as some type of a message.

FIG. 3 also provides a number of data storage means, including building level BAS data 335, utility data 340, and building data 345. Data stores 335, 340, and 345 may be part of a distributed storage system. While three different data storage devices are depicted, any number of data storage devices may be employed in some embodiments. The data elements in the data stores 335, 340, and 345 may be accessible to processing engine 305 and modules 315-330. The data stored on or with databases 335, 340, and 345 may be used by modules 315-330 in the process of carrying out the functionality of the enterprise level BAS 300. In some instances, a data source may provide data to enterprise level BAS for processing and analysis. Module 310 provides a mechanism for additional data to be provided by a third party or data source. Additionally, module 310 may facilitate provisioning of additional applications or modules or a mechanism for updating current applications or modules. As shown, the various modules 315-330, the data storage devices 335-345, and the third party module 310 may be connected to each other by a network, bus, or other communication.

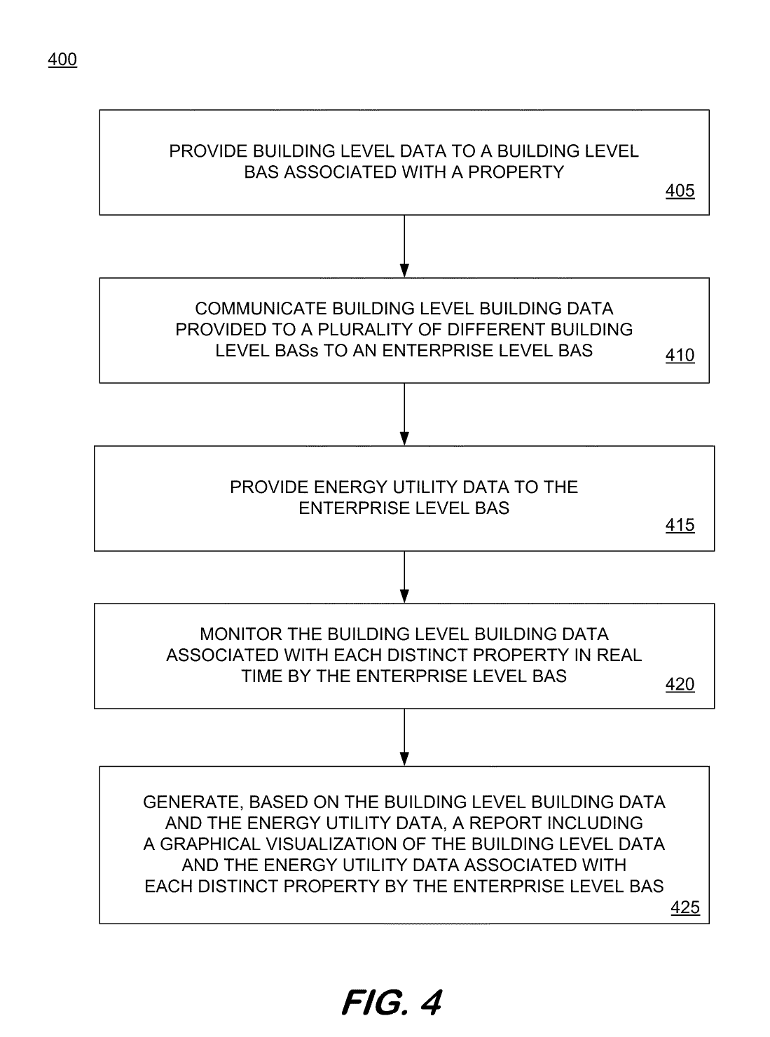

FIG. 4 illustrates one method, by way of flow diagram 400 that might be performed, for example, by the enterprise level BAS 100 described with respect to FIG. 1 according to some embodiments. The flow chart(s) described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 405, data may be provided to a building level BAS associated with a particular property. The building level building data collected by the building level BAS may include a monitor status of building equipment (e.g., temperature, speed, kW, pressure, flow, hours of operation, cost per kW, SAT, RAT, OSA, equipment run hours, fan static, fan speed, zone info, etc.) based on a determined list of points of interest.

At operation 410, building level building data from a plurality of different building level BASs may be communicated to an enterprise level BAS (BAS 155 in FIG. 1). That is, multiple building level BASs communicate their associated building level data to the enterprise level BAS. In some aspects, the present disclosure includes an enterprise level BAS that can communicate with a diverse number and type building level BASs.

At 415, energy utility information is provided to the enterprise level BAS. In some embodiments, the utility data may include, for example, utility rates, utility bills, utility energy historical data, and energy usage values.

At operation 420, the enterprise level BAS monitors the data provided by the plurality of building level BASs (e.g., (105, 115, and 125 of FIG. 1) associated with each property in the set of properties being monitored. In this manner, the enterprise level BAS may provide a centralized monitoring of the diverse local building BASs.

At operation 425, the enterprise level BAS generates, based on the building level building data and the energy utility data, a report including a graphical visualization of the building level data and the energy utility data associated with each distinct property by the enterprise level BAS. The generating of the report may include or rely on a transformation of the building level building data and an analysis of same prior to the generating of the report. In some embodiments, a set of reports may be generated that allow for efficient retro-commissioning for each property, including tracking of equipment statistics against default statistics.

In some embodiments, other processes may further include analyzing the building level building data and the energy utility data associated with each distinct property by the enterprise level BAS. The analysis may include at least one of the following types of analysis: determining building benchmarking, determining portfolio benchmarking, performance determination and evaluation, and determining building retro-commissioning action plans.

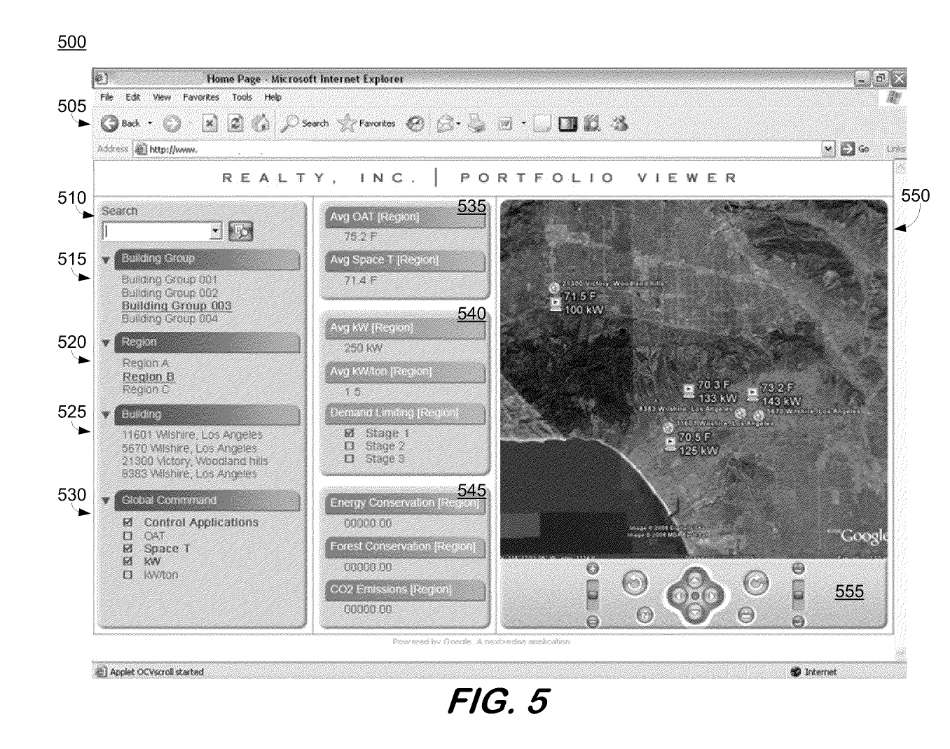

FIGS. 5, 6, and 7 each provide an illustrative example of a report including a dashboard graphical visualization that may be generated by an enterprise level BAS, according to aspects herein. Embodiments of the dashboards herein may be implemented using data structures and communication protocols such that they may be accessed using a browser, including those web browsers known now (e.g., Microsoft® Internet Explorer, Mozilla Firefox®, Apple Safari®, Google Chrome®, etc.) and those that become known in the future. FIG. 5 relates to a dashboard provided via a web browser 505. Portfolio viewer dashboard 500 provides a mechanism for conducting a query of properties controlled, programmed, and otherwise accessed by an enterprise level BAS herein, as illustrated by search box 510. Dashboard 500 also includes mechanisms for searching or selecting a property or group of properties according to a group the building is included in using a building group selector 515, according to a geographical region the building is included in using a region selector 520, and according to a specific address/identifier of the building using a specific building selector 525. Selectors 515-525 may be used to, in some instances, drill down to (or climb up) to a particular level of interest ion the BAS portfolio viewer dashboard 500.

Dashboard 500 also includes a global command section for a user to select which commands and functions they would like to control or invoke via the dashboard. The values for the commands selected via command control 530 may be presented to a user at dashboard regions 535, 540, and 545.

Dashboard 500 also provides a geographical representation of the selected buildings accessed, controlled, and reported on in the dashboard. As shown at 550, a satellite view of a geographical area is depicted, including longitude and latitude data for the monitored and controlled building level BASs controlled by the enterprise level BAS. The dashboard further provides navigational controls 555 for manipulating the area viewed in window 550, including the level of detail included in the views therein. In this manner, a user may quickly and efficiently ascertain a status of the buildings controlled by an enterprise level BAS.

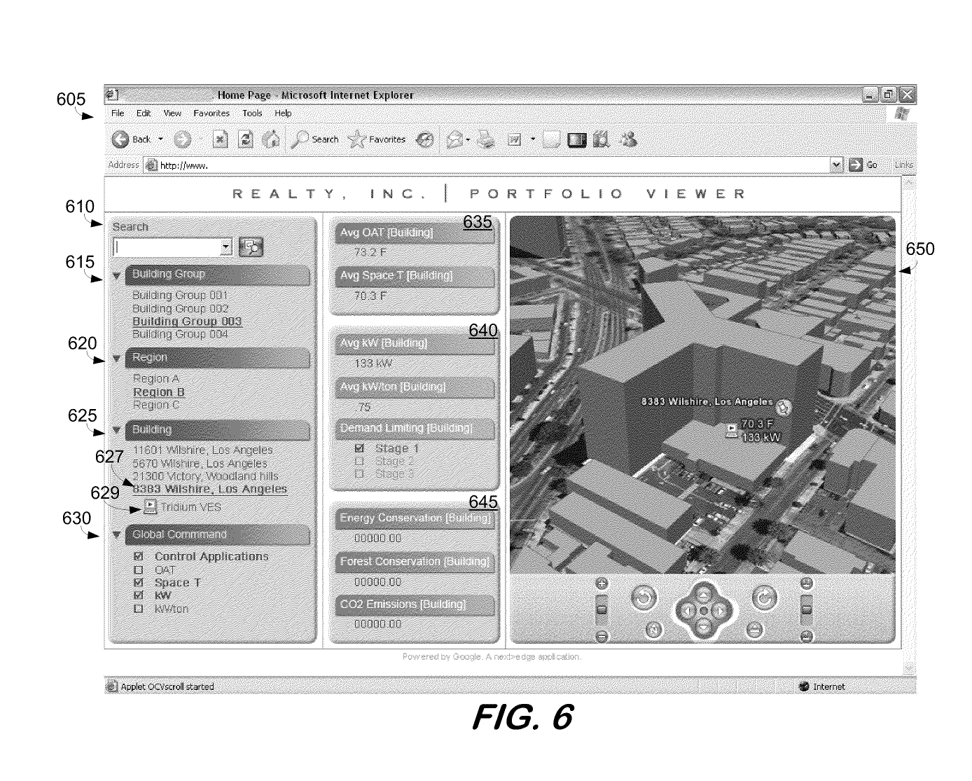

FIG. 6 relates to a dashboard providing a graphical representation of a particular building controlled by an enterprise level BAS, according to aspects herein. Dashboard 600 is similar to dashboard 500 in some respects. However, dashboard 600 primarily provides information related to a specific building, as opposed to the regional reporting provided by dashboard 500. In particular, dashboard 600 is provided via a web browser 605 and also includes search mechanism 610; building group 615, region 620, and building 625 selectors; and global command mechanism 630. Dashboard 600 provides an example of a particular building be selected by building selector 625. Therefore, the commands selected and the corresponding values shown at 635-645 relate specifically to the building selected and graphically shown at window 650. The particularly selected building 627 is highlighted, and the particular building level BAS configuration for the selected building is indicated at 629.

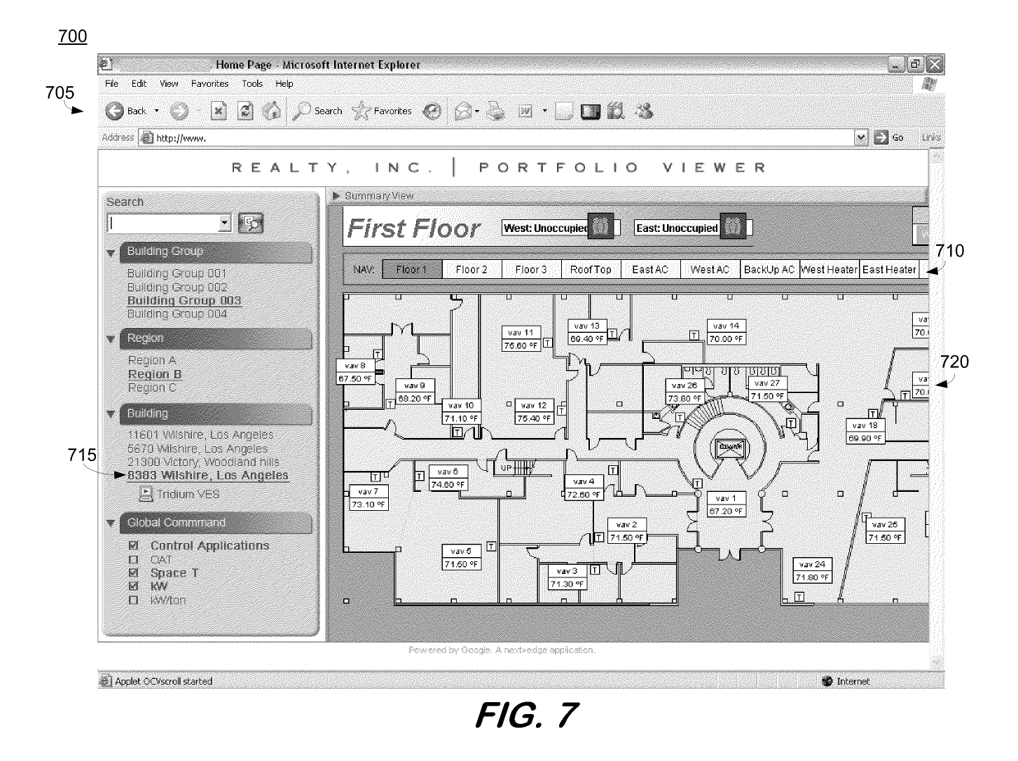

FIG. 7 relates to dashboard providing a graphical representation of a building floor plan for a selected building and a graphical presentation of the floor plan with annotations indicative of a condition of the equipment and/or environment in particular areas of the building controlled by an enterprise level BAS, according to aspects herein. Dashboard 700 is similar in some aspects to dashboards 500 and 600. However, dashboard 700 primarily provides detailed information related to a specific portion of a building, as opposed to a regional or building level reporting provided by dashboards 500 and 600, respectively. For example, dashboard 700 provides a mechanism to navigate the different areas or sub-areas 710 of the selected building 715. In some embodiments, dashboard 700 includes a graphical presentation of the building's floor plan with color coded temperature zones. Window view 720 provides a listing of the actual measurements at the particularly monitored areas/equipment providing the basis of a report.

While specific implementations and hardware configurations for an enterprise level BAS have been illustrated, it should be noted that other implementations and hardware configurations are possible and that no specific implementation or hardware configuration is needed. Thus, not all of the components illustrated herein may be needed for a device, apparatus, and system implementing one or more of the methods disclosed herein.

What is claimed is:

1. A computer-implemented method for an enterprise level building automation system, the method comprising:
providing building level data to a building level building automation system (BAS) associated with a property, the building level data including a status of building equipment associated with the property;
communicating building level building data provided to a plurality of different building level building automation systems (BASs) to an enterprise level BAS, each of the plurality of different building level BASs being associated with a distinct property;
providing energy utility data to the enterprise level BAS;
monitoring the building level building data associated with each distinct property in real time by the enterprise level BAS; and
generating, based on the building level building data and the energy utility data, a report including a graphical visualization of the building level data and the energy utility data associated with each distinct property by the enterprise level BAS.

2. The method of claim 1, further comprising analyzing the building level building data and the energy utility data associated with each distinct property by the enterprise level BAS, wherein the analysis includes at least one of the following: determining building benchmarking, determining portfolio benchmarking, performance determination and evaluation, and determining building retro-commissioning action plans.

3. The method of claim 1, wherein at least two of the plurality of different building level BASs communicate using different communication protocols.

4. The method of claim 1, wherein the generating of the report by the enterprise level BAS includes a graphical visualization of the building level building data and the energy utility data associated with a subset of all of the distinct properties.

5. The method of claim 4, wherein the subset is defined based on at least one of a property type, a property characteristic, and a property location.

6. The method of claim 1, wherein the enterprise level BAS automatically identifies energy inefficiencies based on the building level data provided by the plurality of different building level BASs and the energy utility data.

7. The method of claim 6, wherein the enterprise level BAS further automatically determines a financial impact corresponding to the identified energy inefficiencies.

8. The method of claim 1, further comprising providing weather data associated with the distinct properties to the enterprise level BAS.

9. The method of claim 1, wherein the report graphical visualization is customizable for tiered reporting to different users based on at least one of user type and user authorization.

10. The method of claim 1, wherein the report graphical visualization provides a graphical representation of equipment at the property and a corresponding indication of a status of the building equipment.

11. An enterprise level building automation system, the system comprising:
a plurality of different building level building automation systems (BASs), each for collecting building level building data associated with a distinct property and the building level data including a status of building equipment associated with each distinct property; and
an enterprise level BAS comprising a processor and a storage device in communication with the processor and storing instructions adapted to be executed by the processor to:
receive the building level build data collected by the plurality of different building level BASs;
receive energy utility data associated with the distinct properties associated with the plurality of different building level BASs;
monitor the building level data associated with each distinct property in real time by the enterprise level BAS; and
generate, based on the building level data and the energy utility data, a report including a graphical visualization of the building level data and the energy utility data associated with each distinct property by the enterprise level BAS.

12. The system of claim 11, wherein the storage device further stores instructions adapted to be executed by the processor to:
analyze the building level building data and the energy utility data associated with each distinct property by the enterprise level BAS, wherein the analysis includes at least one of the following: determining building benchmarking, determining portfolio benchmarking, performance determination and evaluation, and determining building retro-commissioning action plans.

13. The system of claim 11, wherein at least two of the plurality of different building level BASs communicate using different communication protocols.

14. The system of claim 11, wherein the report by the enterprise level BAS includes a graphical visualization of building level building data and the energy utility data associated with a subset of all of the distinct properties.

15. The system of claim 14, wherein the subset is defined based on at least one of a property type, a property characteristic, and a property location.

16. The system of claim 11, wherein the enterprise level BAS further automatically identifies energy inefficiencies based on the building level data provided by the plurality of different building level BASs and the energy utility data.

17. The system of claim 16, wherein the enterprise level BAS further automatically determines a financial impact corresponding to the identified energy inefficiencies.

18. The system of claim 11, further comprising providing weather data associated with the distinct properties to the enterprise level BAS.

19. The system of claim 11, wherein the report graphical visualization is customizable for tiered reporting to different users based on at least one of user type and user authorization.

20. The system of claim 11, wherein the report graphical visualization provides a graphical representation of equipment at the distinct properties and a corresponding indication of a status of the equipment.
